(19) United States
(12) Patent Application Publication
(10) Pub. No.: US 2011/0302098 A1
(43) Pub. Date: Dec. 8, 2011

(54) METHOD AND SYSTEM FOR PROVIDING ANSWERS TO USERS OF A MULTI-TENANT DATABASE SYSTEM

(75) Inventors: Norimasa Yoshida, Daly City, CA (US); Grant Anderson, San Francisco, CA (US); Eric Nash, San Francisco, CA (US); Etienne Giraudy, San Francisco, CA (US); George Su, San Francisco, CA (US); Justin Lin, Coppell, TX (US); Park Kittipatkul, Foster City, CA (US); Vinodh Rajagopal, Sunnyvale, CA (US); Irina Sendyk, San Mateo, CA (US); Anshu Agarwal, San Francisco, CA (US); Sriram Rangaraj, Sunnyvale, CA (US)

(73) Assignee: Salesforce.com, Inc., San Francisco, CA (US)

(21) Appl. No.: 13/152,246

(22) Filed: Jun. 2, 2011

Related U.S. Application Data
(60) Provisional application No. 61/351,620, filed on Jun. 4, 2010.

(51) Int. Cl. G06F 15/16; G06Q 99/00

(52) U.S. Cl. 705/319; 709/205

(57) ABSTRACT

Online communities, also referred to as “forums,” are used as a customer support tool along with a repository of useful articles, also referred to as “knowledge base.” Users may navigate between the forum and the knowledge base. Social networks can also be used to access the forum and knowledge base. Forums and knowledge bases that have confidential data may be restricted to employees of a multi-tenant database system. Any of the above embodiments can be used independently or together with any combination of other embodiments.

### CLAIM OF PRIORITY

This application claims the benefit of U.S. Provisional Patent Application 61/351,620 entitled METHODS AND SYSTEMS FOR PROVIDING ANSWERS TO USERS OF A MULTI-TENANT DATABASE SYSTEM, by Norimasa Yoshida et al., filed Jun. 4, 2010 (Attorney Docket No. SALESP0004P/384PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS REFERENCE TO RELATED APPLICATIONS

The following commonly owned, co-pending or other United States patents and patent applications, including the present application, are related to each other. Each of the other patents/applications listed below are incorporated by reference herein in its entirety:

U.S. patent application Ser. No. 11/716,365 entitled METHOD AND SYSTEM FOR POSTING IDEAS, by Norimasa Yoshida et al., filed Mar. 8, 2007 (Attorney Docket No. 48-2), which is now U.S. Pat. No. 7,831,455; and

U.S. patent application Ser. No. 11/786,882 entitled METHOD AND SYSTEM FOR MANAGING IDEAS, by Norimasa Yoshida et al., filed Apr. 13, 2007 (Attorney Docket No. 48-3/042US), which is now U.S. Pat. No. 7,818,194; and

U.S. patent application Ser. No. 11/801,572 entitled METHOD AND SYSTEM FOR INTEGRATING IDEA AND ON DEMAND SERVICES, by Norimasa Yoshida et al., filed May 9, 2007 (Attorney Docket No. 48-4/043US), which is now U.S. Pat. No. 7,840,413; and

U.S. Provisional Patent Application No. 61/350,904 entitled METHOD AND SYSTEM FOR CASES TO ESCALATION, by Norimasa Yoshida et al., filed Jun. 2, 2010 (Attorney Docket No. 48-49); and

U.S. Provisional Patent Application No. 61/354,604 entitled METHODS AND SYSTEMS FOR DYNAMICALLY SUGGESTING ANSWERS TO QUESTIONS SUBMITTED TO A PORTAL OF AN ONLINE SERVICE, by Patrick McFarlane et al., filed Jun. 14, 2010 (Attorney Docket No. SALEP0030P); and

U.S. patent application Ser. No. ______ entitled METHODS AND SYSTEMS FOR DYNAMICALLY SUGGESTING ANSWERS TO QUESTIONS SUBMITTED TO A PORTAL OF AN ONLINE SERVICE, by Patrick McFarlane et al., filed ______ (Attorney Docket No. 48-51/429US); and

U.S. Provisional Patent Application No. 61/360,752 entitled METHODS AND SYSTEMS FOR SCORING AND RANKING ARTICLES IN AN ON-DEMAND SERVICES ENVIRONMENT, by Vinodh Rajagopal, filed Jul. 1, 2010 (Attorney Docket No. SALEP0034P); and

U.S. patent application Ser. No. ______ entitled METHOD AND SYSTEM FOR SCORING ARTICLES IN AN ON-DEMAND SERVICES ENVIRONMENT, by Vinodh Rajagopal, filed ______ (Attorney Docket No. 48-52/436US); and

U.S. Provisional Patent Application No. 61/351,620 entitled METHODS AND SYSTEMS FOR PROVIDING ANSWERS TO USERS OF A MULTI-TENANT DATABASE SYSTEM, by Norimasa Yoshida et al., filed Jun. 4, 2010 (Attorney Docket No. SALEP0004P); and

U.S. patent application Ser. No. ______ entitled METHOD AND SYSTEM FOR PROVIDING ANSWERS TO USERS OF A MULTI-TENANT DATABASE SYSTEM, by Norimasa Yoshida et al., filed ______ (Attorney Docket No. 48-54/384US); and

U.S. Provisional Patent Application No. 61/350,904 entitled METHOD AND SYSTEM FOR ANSWERS TO CASES ESCALATION, by Norimasa Yoshida et al., filed Jun. 2, 2010 (Attorney Docket No. SALEP0005P); and

U.S. patent application Ser. No. ______ entitled METHOD AND SYSTEM FOR ESCALATING CONTENT OF DISCUSSIONS TO PARTICULAR MEMORY LOCATIONS, by Norimasa Yoshida et al., filed ______ (Attorney Docket No. 48-55/385US).

### FIELD OF THE INVENTION

The specification relates generally to providing answers to users of a multi-tenant database system.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Some forms of supporting customers are phone support or email support. With the advent of the web, however, software-like utility is increasingly delivered to users as a service. These so called “software as a service” approaches may include a group of end users, who may wish to use the service offering collaboratively, or who may wish to share their input as a community. A database created from collaborative sharing in a community also known as “forum” is being widely used as an added tool for customer support. Accordingly, it is desirable to provide techniques enabling sharing ideas to improve service offerings.

### BRIEF DESCRIPTION OF THE DRAWINGS

In the following drawings like reference numbers are used to refer to like elements. Although the following figures depict various example's, the one or more implementations are not limited to the examples depicted in the figures.

FIG. 1 shows a block diagram of an embodiment of a server system.

FIG. 2 shows a block diagram of an embodiment of a forum system in a multi-tenant database system.

FIG. 3 shows a block diagram of an embodiment of an internal forum system in a multi-tenant database system.

FIG. 4 shows a flowchart illustrating an embodiment of a client-side method of providing access to a forum system.

FIG. 5 shows a flowchart illustrating an embodiment of a intermediate server-side method of providing access to a forum system.

FIG. 6 shows a flowchart illustrating an embodiment of a end server-side system method of providing access to a forum system.

FIG. 7 shows a flowchart illustrating an embodiment of a user system method of providing access to an internal forum system.

FIG. 8 shows a flowchart illustrating an embodiment of a server-side system method of providing access to an internal forum system.

FIG. 9 shows a block diagram illustrating an embodiment of a categorization method of providing answers in forum system.

FIG. 10 shows a flowchart illustrating an embodiment of a categorization method of providing answers in forum system.

FIG. 11 shows screenshot of an embodiment of a social network page with link to forum.

FIG. 12 shows screenshot of an embodiment of a forum.

FIG. 13 shows screenshot of an embodiment of an answer webpage.

FIG. 14 shows screenshot of an embodiment of an answer webpage.

FIG. 15 illustrates an embodiment of an environment wherein as on-demand database service might be used for methods and systems for providing answers.

FIG. 16 illustrates an embodiment of elements of FIG. 15 and various possible interconnections between elements in an embodiment for methods and systems for providing answers.

FIG. 17 illustrates an embodiment of an environment within which the system for providing answers may operate.

FIG. 18 illustrates embodiment of elements of FIG. 17 and various possible interconnections between elements of the environment.

### DETAILED DESCRIPTION

### General Overview

Systems and methods are provided for answers to users of a multi-tenant database network system.

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers. In an embodiment, the multi-tenant database system is a computing environment accessible to multiple independent users and the tenants of the database system can have their own ecosystem of a database system. The tenants of the multi-tenant database system do not have to install software or maintain backups, software service and maintenance is available to all the tenants of the multi-tenant database system.

Next, mechanisms and methods for providing answers to users will be described with reference to example embodiments. In this specification a community is a group of users that share a common interest and tend to communicate with one another about that common interest. A community website is a website in which users share ideas that are related to the community. An on-demand community is a community website that is created by the tenant using pre-established tools specialized for creating communities. In an embodiment, the focus of the communities may be on on-demand enterprise communities, which are communities structured around a business' eco system: partners, customer, vendors, employees, etc.

In this specification the terms forum, web forum, and community website may be interchanged with one another to obtain different embodiments. Additionally, forum content may be used to refer to questions, answers, exchanges of comments, and/or other content discussed in a forum. The forum may include various features and/or tools that are available to users and/or administrators.

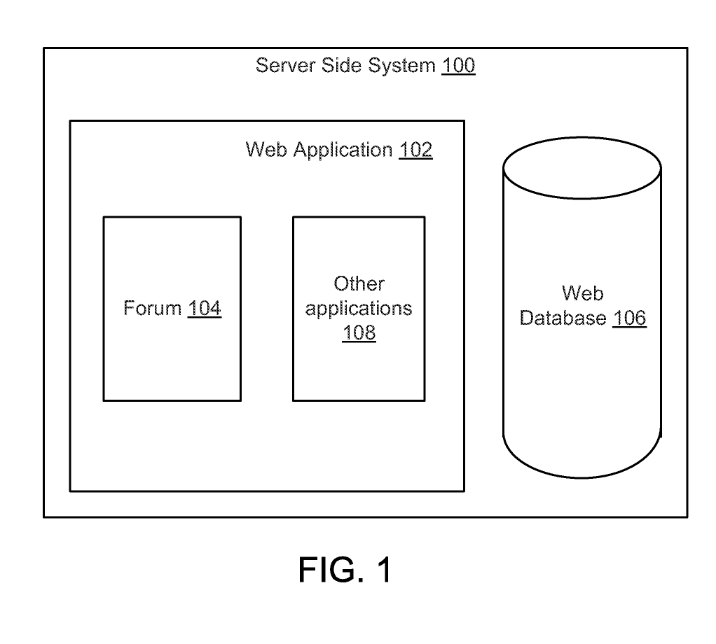

FIG. 1 shows an embodiment of a server-side system 100 in an on-demand database service. In an embodiment, the server-side system 100 may host web application 102, forum 104, web database 106 and other applications 108. In other embodiments server-side system 100 may not have all of the elements or features listed and/or may have other elements or features instead of or in addition to those listed.

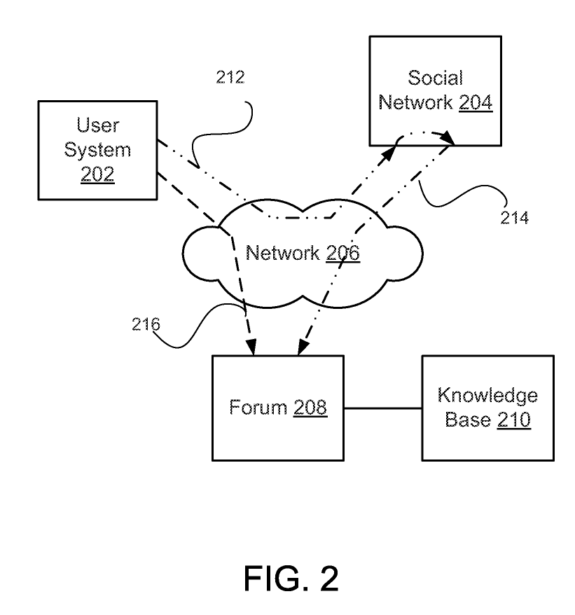

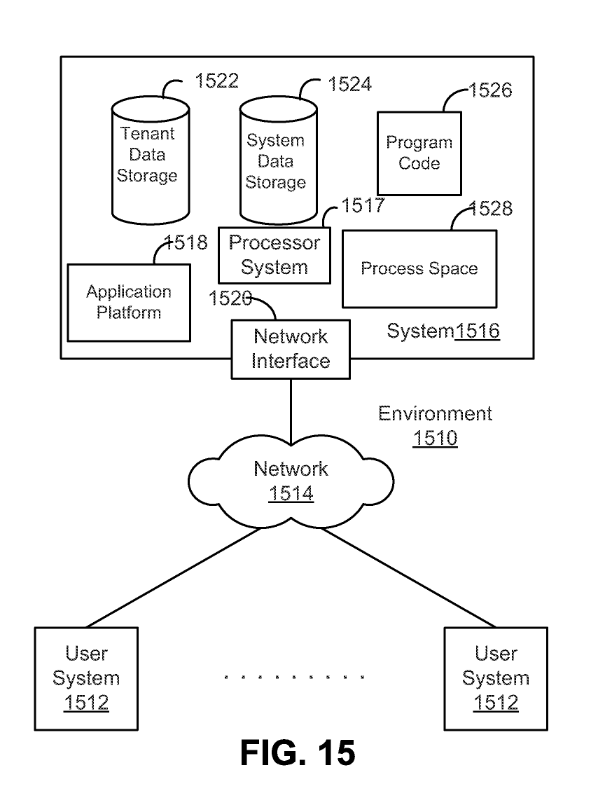

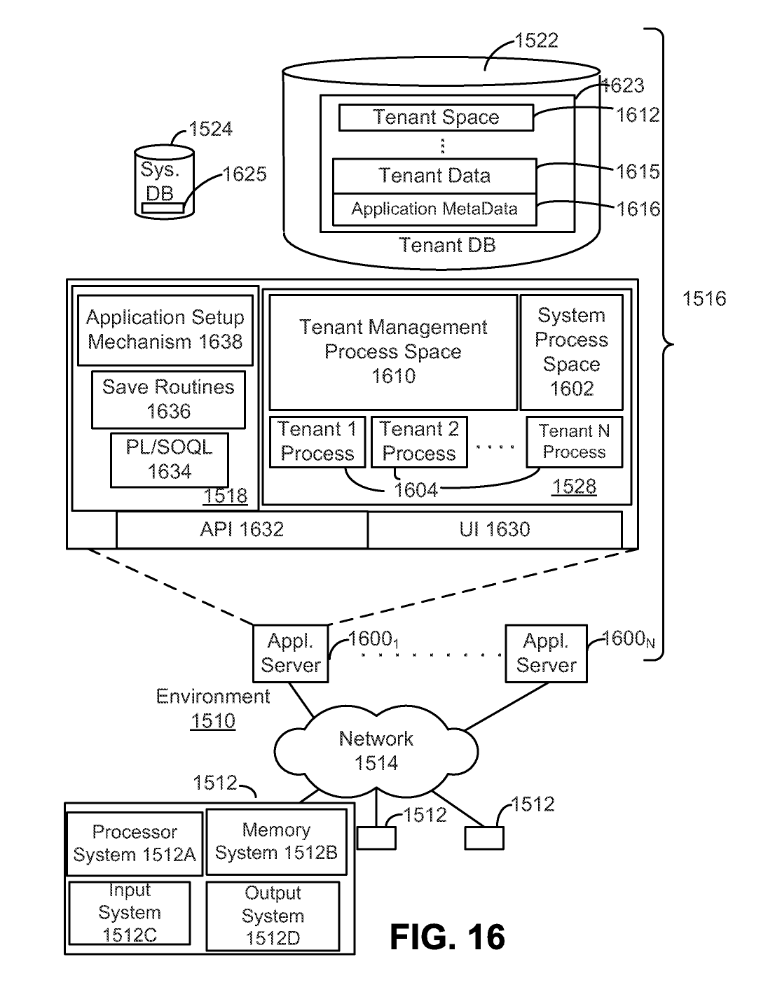

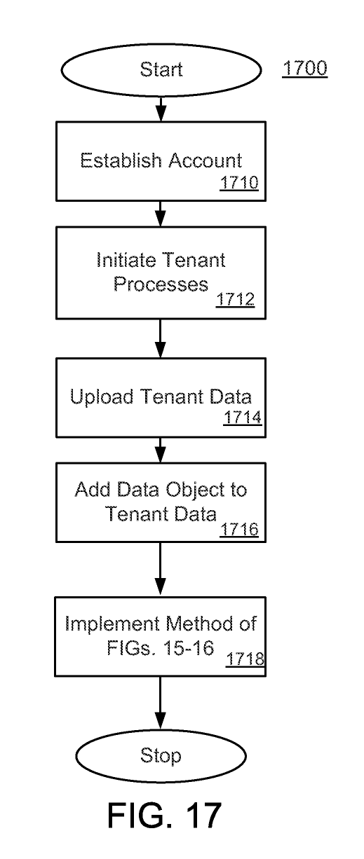

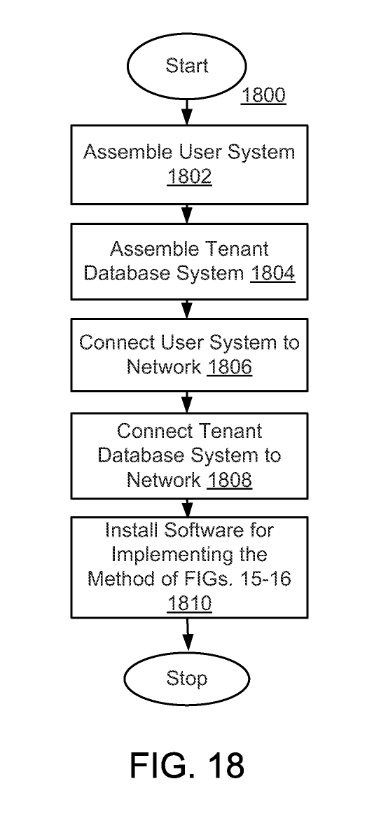

In an embodiment in a multi-tenant database system, web application 102 sends web pages to the user system (which will be described in conjunction with FIG. 15), receives information from the user via information entered into fields of the webpage, and/or receives information generated by the user interacting with the webpage, such as by selecting links. Web application 102 includes one or more instructions that cause a processor to render a webpage. Rendering a webpage may involve performing computations, such as retrieving information. Forum 104 may be a community website where the members can have conversations in the form of posted messages. The members may have a common goal of discussing a product. In an embodiment, the members of forum 104 may have to register with forum 104 and login in order to gain access to forum 104. In an embodiment, after the member logs into forum 104, the member may read the questions that were posted by other members, read the answers to the posted questions by other members, post a question, reply to a question and rate the answers to the question posted by other members, and/or search for content related to a topic or product. In an embodiment, forum 104 can be part of a forum system that includes a knowledge base (discussed in conjunction with FIG. 2) so the users can search for answers.

Web database 106 is a database associated with web application 102. As a result of implementing web application 102, server side system 100 may access web database 106 to store information received from user system. Web application 102 can reside in tenant data (which will be described in conjunction with FIG. 15). As a result of implementing web application 102, server side system 100 may also retrieve data from web database 106 that is useful for computations made by web application 102 and/or for rendering a web page of the website to send to the user system (which will be described in conjunction with FIG. 15). Web database 106 may store information necessary for rendering web pages associated with web sites. Web application 102 may host forum 104 and other applications. In an embodiment, the content of the knowledge base can reside in web database 106. Web Application 102 facilitates forum 104 and helps in organizing the questions and answers presented by the user system and storing the content of the forum in web database 106. Other applications 108 can be any other web applications such as customer account management software or word processing software.

System of Providing Answers with Social Network

FIG. 2 shows an embodiment of a system providing answers to the users. In an embodiment, the system may have user system 202, social network 204, network 206, forum 208, knowledge base 210, user system-social network path 212, social network—forum path 214 and direct path 216. In other embodiments the system may not have all of the elements or features listed and/or may have other elements or features instead of or in addition to those listed.

Traditional forums have focused on providing a meeting place for a virtual community of interne users who share common interest. However, forums can also be used for lowering costs in a business context by providing a cheaper avenue for customer service. Instead of calling into a call center where a human agent takes calls and answers questions, forums can provide a more scalable method where customers can help each other answer their own questions.

Knowledge base is a database for knowledge management. Knowledge base is a collection of articles related to problems and solutions. Knowledge base systems are tools that help in creating, editing, and managing the database of articles. Knowledge base systems offer documentation of knowledge and self-learning by reducing the cost of customer support. In this specification, aforum system refers to a forum that has access to a knowledge base, the forum and the knowledge base can be navigated easily. A social network is a social structure made up of individuals or organizations which are connected by one or more specific types of interdependency, such as friendship, common interest, dislike or knowledge. In this specification, social network service refers to an online service or site that focuses on building and reflecting of social networks. A social network service provides means for users to interact over the internet, such as by e-mail and instant messaging and allow users to share ideas, activities, events, and interests within their individual networks. Members of social network services may also allow users to leave messages on their own page for others to read, leave messages on a communal page available to some or all members, leave messages on other's pages, form discussion groups. Some examples of social networks are Facebook, Linked-in, MySpace, and Twitter are the most widely used social networking services.

In an embodiment, user system 202 (which will be discussed further in conjunction with FIG. 15) may be any machine or system that is used by a user to access a network or a server system (discussed further in conjunction with FIG. 15). Social network 204 may be a social network service that may be accessed by the user system via the internet. Network 206 (further discussed in conjunction with FIG. 15) is any network or combination of networks of devices that communicate with one another. User system 202 may interact, via network 206, with social network 204 and forum 208. In an embodiment, forum 208 can be the same as forum 104 (discussed in conjunction with FIG. 1). Knowledge base 210 is a formal knowledge base published by the company that hosts the forum. In an embodiment, the user of forum 208 can also access knowledge base 210. Access to knowledge base 210 enables users to search for answers in knowledge base 210 and post questions or replies in forum 208. Knowledge base 210 may not have all the solutions to users' queries or problems or answers to new issues. Forum 208 provides the users with an alternative form of customer support by allowing users to post questions in forum 208 and letting peers reply, thereby reducing the burden on the customer support staff. Also, in an embodiment users may be able to search forum 208 for prior questions and answers that relate to the user's concerns. By allowing user to post questions and search previously posted questions, forum 208 can function as an informal knowledge base. User system-social network path 212 (indicated by a broken line with a dash and two dots, which is different from other lines, solid or broken line with dashes) shows the path connecting user system 202 to social network 204 via network 206. Social network-forum path 214 (indicated by a broken line with dash and two dots) shows that route connecting social network 204 and forum 208 via network 206. Direct path 216 shows the path connecting user system 202 to forum 208 via network 206. User system 202 may gain access to forum 208 by following the route—user system 202, user system-social network path 212, social network 204 and social network-forum 214.

In an alternative embodiment user system 202 may access forum 208, via network 206, directly without social network 204 and the path is indicated by direct path 216 in a broken line with dashes in FIG. 2.

### System of Providing Answers Inside an Internal Enterprise

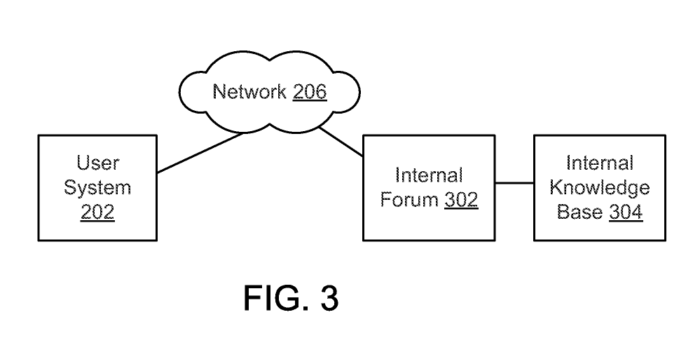

FIG. 3 shows an embodiment of a system providing answers internally to an enterprise. In this embodiment, the system comprises user system 202, network 206, internal forum 302, and internal knowledge base 304. In other embodiments the system may not have all of the elements or features listed and/or may have other elements or features instead of or in addition to those listed.

In a company, some employees have expertise in certain domains and their knowledge of the domain may be due to their work experience. Many times the information is not documented or the document may be in various media, formats, or in different geographical locations. Large companies have a bigger problem of assimilating useful undocumented information. Searching for information may be challenging. In this specification, a method of collecting information is disclosed that could be internal to a company. The method may also provide navigation techniques for accessing the database of information internal to the company.

Regarding FIG. 3, user system 202 and network 206 are discussed earlier in conjunction with FIG. 2. Internal forum 302 may be a forum similar to forum 208 and internal knowledge base 304 may be similar to knowledge base 210. However, in contrast to forum 208 and knowledge base 210, in an embodiment, internal forum 302 and internal knowledge base 304 may only be accessed by certain user systems that have authorized access. Access to internal forum 302 and internal knowledge base 304 is generally restricted and such user systems can be employees of the multi-tenant database system. In an embodiment, internal forum 302 and internal knowledge base 304 may be accessed via network 206.

Client-Side Method of Providing Answers to Questions for Users, Via a Social Network Service, where the Answers Originally Come from a Forum System (but the Connection from the Forum to the User System is Established by and/or Through the Social Network), where the Client Side System is the User System

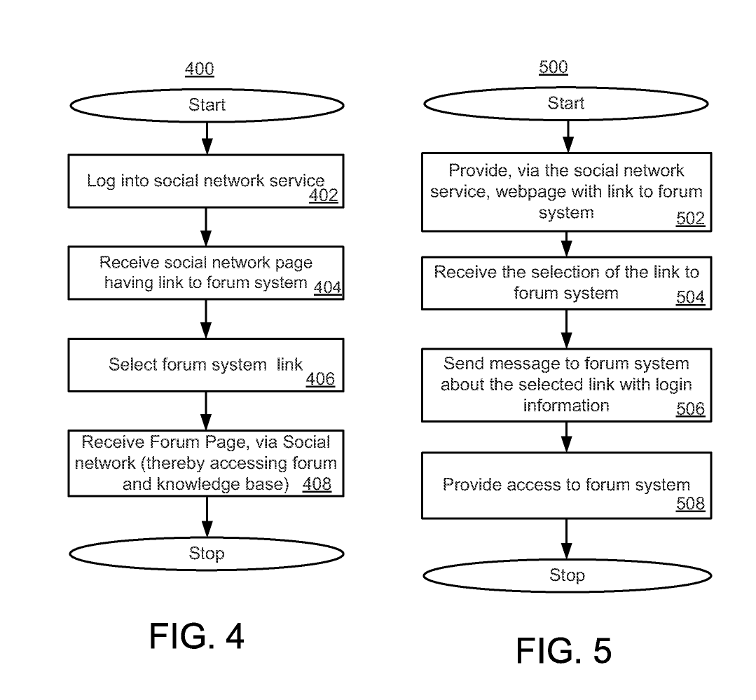

FIG. 4 shows a flowchart of an embodiment of a client-side method 400 for providing answers from a forum system, via a social network service, to a user system. In step 402, the user system (discussed in conjunction with FIG. 15) may send, via a network such as network 206, login information (entered by the user) to a host machine that hosts a social network service for logging into the social network. In step 404, the user system receives a webpage having a link to a forum system comprising at least a forum such as forum 208 and optionally the webpage also has a link for a knowledge base, such as knowledge base 210 (FIG. 2). Step 404 may also involve the user system receiving the conversations on the social network service and a link to other webpages along with the link to the forum system. In step 406, the user system may send information to the host system that may include a selection of the link to the forum system, which was received in step 404. The sending of the selection with the link to the forum system may cause the social network service to provide login information to the forum system. In step 408, the user system receives the updated webpage with the forum content and access to the knowledge base via the social network. In an embodiment, as a result of step 408, the user system receives access to the forum and knowledge base, which may involve the user system sending messages to the social network that are intended for the forum system, and in response to the messages sent to the social network that are intended for the forum system, receiving at the user system a message from the social network that originated from the forum system. The messages sent from the user system, via the social network, to the forum system may be a search query or another interaction with the forum webpage, and the message received at the user system, via the social network, from the forum system via the social network to the user system may be a search result or the webpage after being updated to reflect the results of the interaction of the user with the webpage. This process of sending messages from the user system via the social network to the forum system and receiving messages at the user system, via the social network, from the forum system, may be repeated many times, except with different messages. In an alternative embodiment the social network just sets up the initial connection, and after the connection between the social network and the user system is established, messages travel between the user system and the forum system without traveling through the social network while in route.

In an embodiment, each of the steps of method 400 is a distinct step. In other embodiments, method 400 may not have all of the above steps and/or may have other steps in addition to or instead of those listed above. The steps of method 400 may be performed in another order. Subsets of the steps listed above as part of method 400 may be used to form their own method. In an embodiment, there could be multiple instances of method 400.

Intermediate Server-Side Method of Providing Answers to Questions to a Client System, Via Social Network, from a Forum System, where the Intermediate-Server Refers to the Server System of the Social Network

FIG. 5 shows a flowchart of an intermediate-server-side method 500 for providing answers to questions from a forum system, via a social network service, to a user system (the social network is referred to as the intermediate server, because the server system of the social network is intermediate between the client system and the server system of the forum system). In step 502, in response to receiving the login information from the user system and after authenticating the login information, the server of the social network service provides a webpage with a link to the forum system, and optionally the webpage may also include the social network service conversation. In step 504, the social network service receives, from the user system, a selection of the link to the forum system. In step 506, the social network service system may send a message to the forum system about the selection of the forum system link by a user system. Step 506 may also involve sending the login information from the social network to the forum system. In step 508, the social network service system provides access to the forum and knowledge base, which may involve receiving messages at the social network from the user system that are intended for the forum system, sending the messages from the social network to the forum system, and in response to the messages sent to the forum system from the social network, receiving messages at the social network from the forum system intended for the user system, and the social network system sending the messages (which came from the forum system) to the user system. The messages received from the user system, at the social network system, and forwarded to the forum system may be a search query or another interaction with the forum webpage, and the message sent from the forum system to the social network system and forwarded to the user system may be a search result or a webpage. This process of sending messages from the user system via the social network to the forum system and from the forum system social network, via the social network, to the user system, may be repeated many times, except with different messages. In an embodiment, the social network creates an iframe that is available to the user system and has a webpage of the forum system via the user system.

In an embodiment, each of the steps of method 500 is a distinct step. In other embodiments, method 500 may not have all of the above steps and/or may have other steps in addition to or instead of those listed above. The steps of method 500 may be performed in another order. Subsets of the steps listed above as part of method 500 may be used to form their own method. In an embodiment, there could be multiple instances of method 500.

End Server-Side Method of Providing Answers to Questions to a Client System, Via Social Network Service, Form a Forum System, where the End Server Refers to the Server System of the Forum System

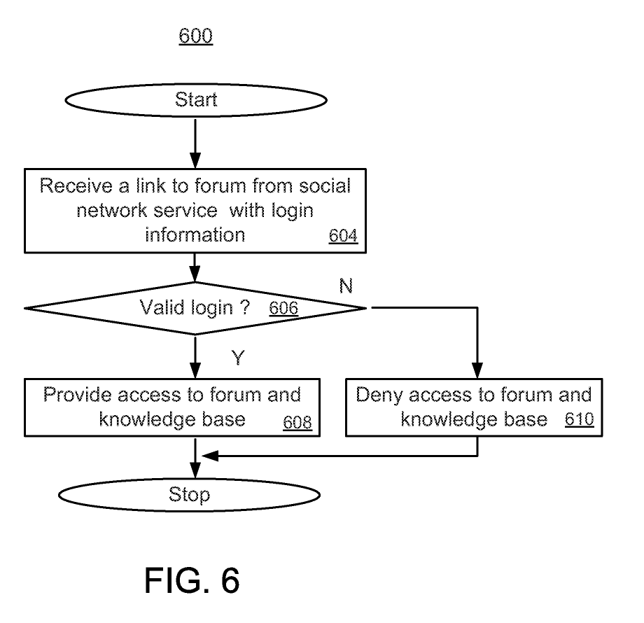

FIG. 6 shows a flowchart of an embodiment of an end-server-side method 600 for providing answers to questions from a forum system, via a social network, to a user system (the forum's server system is at the end of the communications path in from the user system through the social network to the forum system and is therefore referred to as the end-server). The server (discussed in conjunction with FIG. 15) provides a link to the forum in the social network which can be part of the setup process. The link may be provided, via a software application that resides on the server of the social network. In step 604, the end-server (which is on the forum system) receives from the social network an indication that the link (at the social network) to forum has been selected. In an embodiment, in step 604, along with the indication of the selection of the link, the server at the forum system may receive from the social network system login information, such as the username and password associated with the user. In decision box 606, the server at the forum system checks whether the login information received is valid by comparing the received username and password with the username and password stored at the forum system. If the login information is valid, then the server at the forum system proceeds to step 608. Otherwise, if the login information is not valid, then the server at the forum system proceeds to step 610. In step 608, the server enables access to the forum and the knowledge base. In an embodiment, as a result of step 608, the user system receives access to the forum and knowledge base, which may involve the forum system receiving messages from the social network that originated from the user system, in response sending to the user system a message to the social network that is intended for the user system. The messages received at the forum system, via the social network, from the user system may be a search query or another interaction with the forum webpage, and the message sent from the forum system, via the social network, to the user system may be a search result or the webpage after being updated to reflect the results of the interaction of the user with the webpage. This process of sending messages from the forum system via the social network to the user system and receiving messages at the forum system, via the social network, from the user system social system, may be repeated many times, except with different messages. In step 610, the server of the forum system sends a message to the social network system indicating that the login information is invalid information provided by the social network service to the forum system and does not allow access to the forum and the knowledge base.

In an embodiment, each of the steps of method 600 is a distinct step. In other embodiments, method 600 may not have all of the above steps and/or may have other steps in addition to or instead of those listed above. The steps of method 600 may be performed in another order. Subsets of the steps listed above as part of method 600 may be used to form their own method. In an embodiment, there could be multiple instances of method 600.

### Client-Side Method of Providing Answers to Questions for Users Via an Internal Forum System

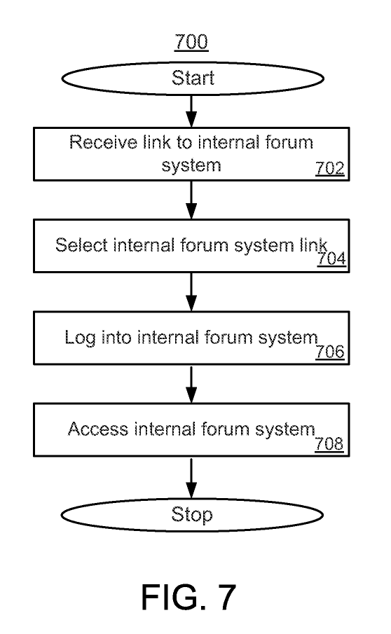

FIG. 7 shows a flowchart of an embodiment of a method 700 for a client-side method of providing answers to questions for users, via an internal forum system. In step 702, in an embodiment, the user system receives a webpage having a link to the internal forum system. In an embodiment, the internal forum system can be internal forum 302 and knowledge base 304 (which were discussed earlier in conjunction with FIG. 3). Access to the internal forum system may be restricted to employees of the multi-tenant database system. In step 704, the user system sends an indication that the link has been selected link to the internal forum system. In step 706, the user system receives the updated webpage with a login form and the user system provides the username and the password. In step 708, the user system is provided access to the internal forum and the internal knowledge base.

In another embodiment, the internal forum system can be a forum system comprising of a forum and a knowledge base that is available to the users of the multi-tenant database system.

In an embodiment, each of the steps of method 700 is a distinct step. In other embodiments, method 700 may not have all of the above steps and/or may have other steps in addition to or instead of those listed above. The steps of method 700 may be performed in another order. Subsets of the steps listed above as part of method 700 may be used to form their own method. In an embodiment, there could be multiple instances of method 700.

### Server-Side Method of Providing Answers in an Internal Forum System

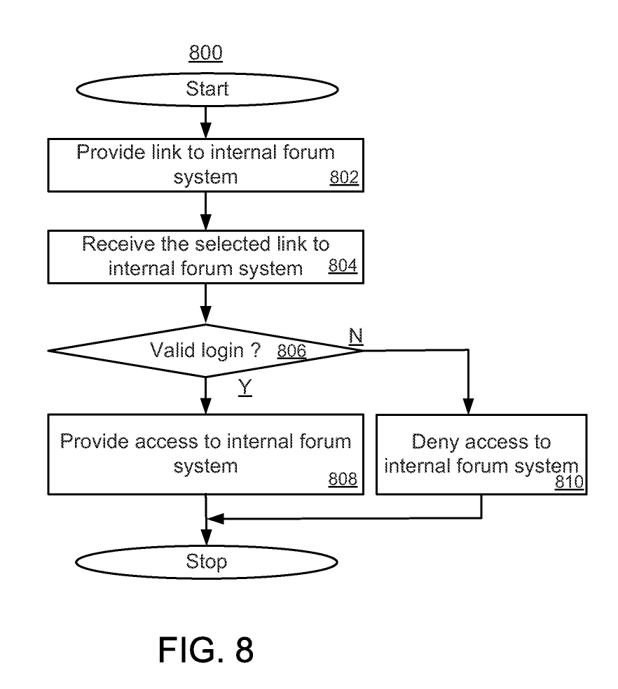

FIG. 8 shows a flowchart of an embodiment of a server-side method 800 for providing answers to questions from users. In step 802, the server (discussed in conjunction with FIG. 15) provides a webpage with a link to a forum system to the user system (discussed in conjunction with FIG. 15). The forum system can comprise of an internal forum 302 and internal knowledge base 304 (discussed earlier in FIG. 3). In step 804, the server receives the selected link to the forum system. In step 804, along with selected link, the server may receive the login data including the username and password. In decision box 806, the server decides whether the login data is valid by comparing the received username and password with the username and password that is stored in the system. If the server can validate the login data, then the server proceeds to step 808. In step 808, the server enables access to the forum and the knowledge base. In step decision box 806, if the server cannot validate the login then it proceeds to step 810. In step 810, the server sends a webpage with a message that the server was not able to validate the login and denies access to the forum and the knowledge base.

In another embodiment, the forum system can comprise of forum 208 and knowledge base 210. In an embodiment, each of the steps of method 800 is a distinct step. In other embodiments, method 800 may not have all of the above steps and/or may have other steps in addition to or instead of those listed above. The steps of method 800 may be performed in another order. Subsets of the steps listed above as part of method 800 may be used to form their own method. In an embodiment, there could be multiple instances of method 800.

### Categorization Method

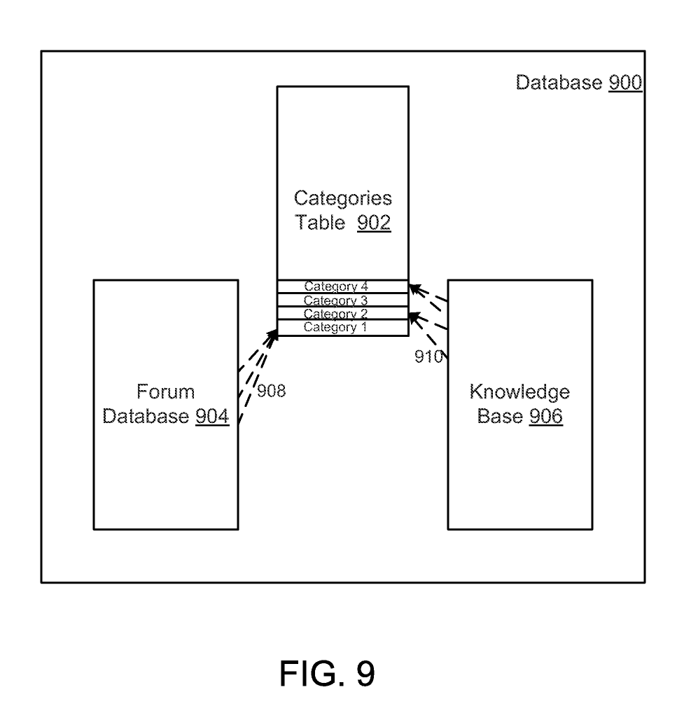

FIG. 9 shows an embodiment of a system of categorization used in the forum system of providing answers to the users in a multi-tenant database system. In an embodiment, the system may have database 900, categories table 902, forum database 904 knowledgebase 906, pointer 908 and pointer 910. In other embodiments the system may not have all of the elements or features listed and/or may have other elements or features instead of or in addition to those listed. Unlike the knowledge base where the content is published by the company, the users provide content to the forum. The content of the forum may be used as a type of informal knowledge base. There is a close relationship between forum and knowledge base and users generally navigate from one database to another. Categorization method provides a unified navigation system for the users allowing them to simultaneously browse the knowledge base articles and the forum conversation.

Regarding FIG. 9, in an embodiment, database 900 may be web database 106 (discussed further in conjunction with FIG. 1). Database 900 can store the categories table 902, forum database 904 and knowledge base 906 among others. Categories table 902 is a table in database 900 storing a list of categories. The categories can be the topic or keywords in the articles in the knowledge base and/or the forum conversation or any other category. In an embodiment, forum database 904 can be the forum conversation that is stored in database 900 and knowledge base 906 may be the knowledge base which is a repository of knowledge articles. Forum conversation and knowledge base articles are classified into categories. Pointer 908 may point to at least a category in the categories table from a forum conversation in forum database 904. There can be multiple pointers pointing from forum database 904 to categories table 902. Similarly, pointer 910 may point to at least a category in the categories table from a knowledge base article in knowledge base 906. There can be multiple pointers from knowledge base 906 to categories table 902.

In another embodiment, forum database 904 can be an internal forum 302 and knowledge base 906 can be internal knowledge base 304.

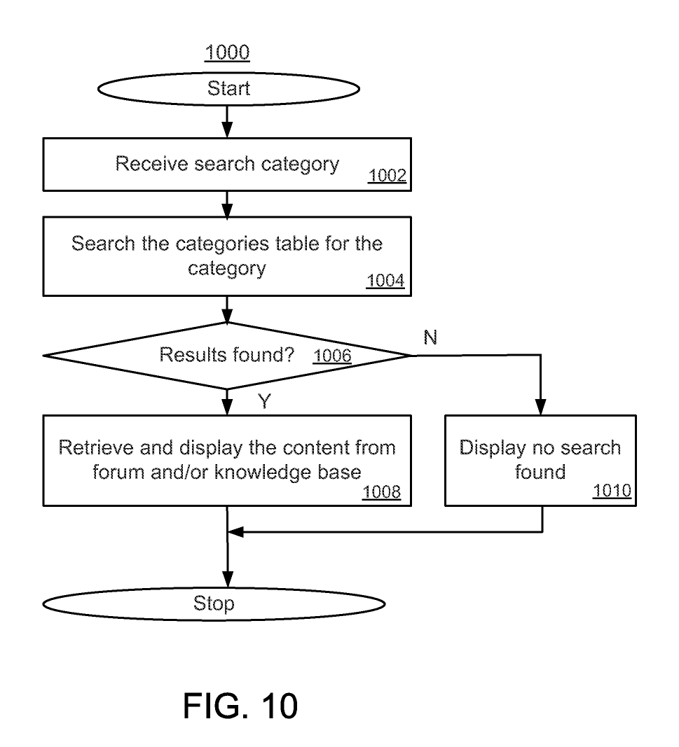

FIG. 10 shows a flowchart of method 1000 illustrating categorization technique used in the method of providing answers. In step 1002, the server (discussed in conjunction with FIG. 15) receives the search term or category. In step 1004, the server searches the categories table for the category. In decision box 1006, the server determines if the category is found and proceeds to step 1008. If the search term is not found, then the server proceeds to step 1010. In step 1008, the server uses the pointers to the forum database and the knowledge base to retrieve forum conversation from the forum database and/or articles from the knowledge base. In step 1010, the server displays a message that the search did not yield any results.

In an embodiment, each of the steps of method 1000 is a distinct step. In other embodiments, method 1000 may not have all of the above steps and/or may have other steps in addition to or instead of those listed above. The steps of method 1000 may be performed in another order. Subsets of the steps listed above as part of method 1000 may be used to form their own method. In an embodiment, there could be multiple instances of method 1000.

### Screenshots

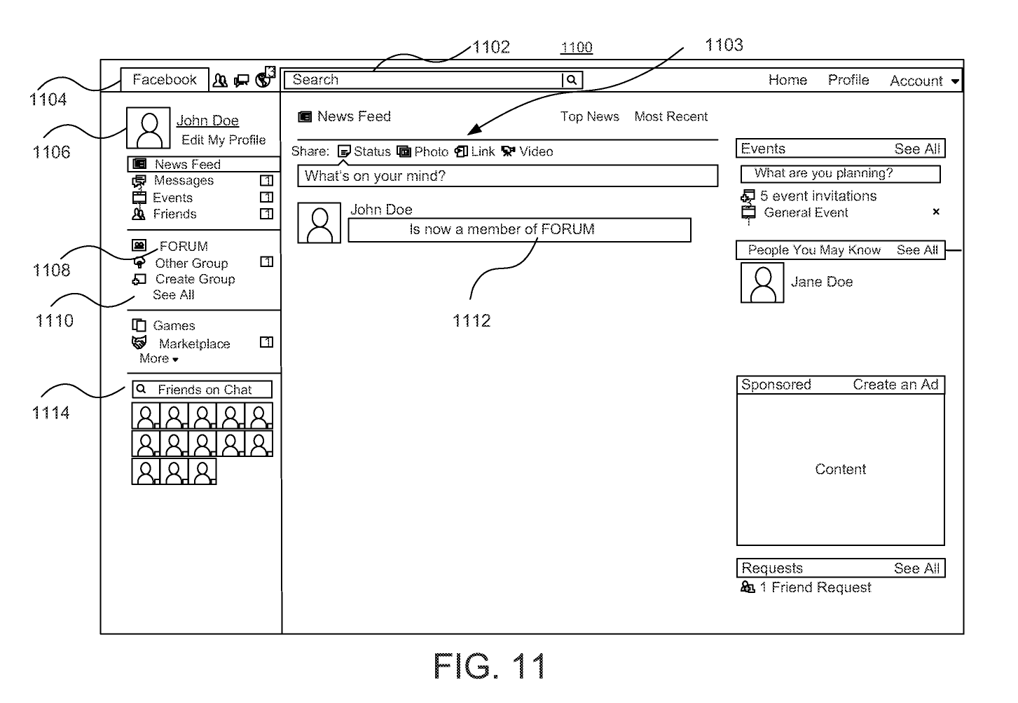

FIG. 11 shows screenshot 1100 of an embodiment of a social network webpage. Screenshot 1100 may include search 1102, share 1103, social network logo 1104, user 1106, Forum link 1108, other links 1110, message 1112, and friends 1114. In other embodiments, webpage 1100 may not have all of the elements listed and/or may have other elements instead of or in addition to those listed.

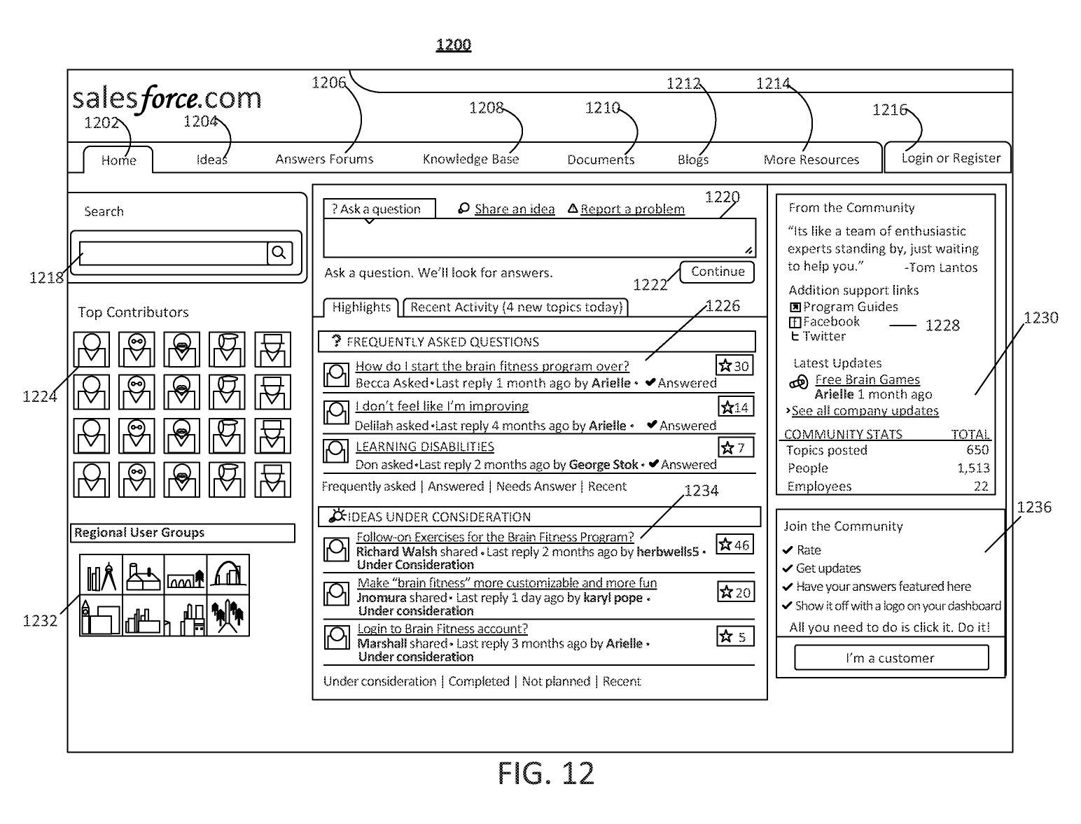

Search 1102 is an input box to search in the social network website. In an alternative embodiment, the home page may be different. Share 1103 is a sharing feature. Members of the social network may share with other members the status of the user, photos, links to other websites and videos. In an embodiment, a user can ask a question from the publisher (via share 1103), have the question display in the UI (of FIG. 11), and have other users directly reply via the UI of FIG. 11 (e.g., as comments under the question). Meanwhile, in the backend, code integrates the two systems such that question/answer sets are stored on the forum system, but the user experience on the social network is seemless. In other words, while accessing the forum content via the social network, the user is not brought to the forum UI, which is a different system than the system of the social network (the forum UI will be discussed in conjunction with FIG. 12).

Social network logo 1104 is the logo of the social network. In an embodiment, Facebook is the social network and hence Facebook logo. In an alternative embodiment, any social network provider's logo can be displayed. User 1106 is the current user of the social network site. The user's identification and picture may be made available. Forum link 1108 is the link to the forum. Forum link 1204, when selected, may cause social network 204 to send the login information to forum 208 via network 206 (social network 204, network 206 and forum 208 are discussed in conjunction with FIG. 2). After the login information is authenticated, a webpage with the forum website appears. Other links 1110 provides links to other groups which the user is a member. Message 1112, is a message box displaying membership of the forum. Friends 1114 lists the friends of user who are currently available for chatting.

FIG. 12 shows screenshot 1200 of an embodiment of a question webpage in a forum. Screenshot 1200 may include home tab 1202, ideas tab 1204, answers forums tab 1206, knowledge base tab 1208, documents tab 1210, blogs tab 1212, more resources tab 1214, login or register tab 1216, search 1218, question box 1220, continue button 1222, top contributors 1224, frequently asked questions 1226, additional support ideas 1228, statistics 1230, regional user groups 1232, ideas under construction 1234 and join the community 1236. In other embodiments, webpage 1200 may not have all of the elements listed and/or may have other elements instead of or in addition to those listed.

Screenshot 1200 is a webpage that contains links for the user to access forum activities such as searching for a topic and browsing forum topic and/or conversations. Screenshot 1200 includes information summarizing the frequently asked questions, answered questions, recent questions, recent forum conversation and various forum topics.

Home tab 1202 when selected may cause a webpage to appear that may be the screenshot 1200. In an alternative embodiment, the home page may be different than the forum page, and the forum may have a tab that is not labeled “forum.” In this alternative embodiment, the forum tab may be labeled “forum” or may have an equivalent label indicating that by selecting the forum tab a forum will be viewed. In the screenshot, home tab 1202 is highlighted indicating a selection of the home tab 1202. Ideas tab 1204, when selected, may cause an ideas-webpage to appear. The ideas-webpage can be an online suggestion box that includes posted ideas, discussions about the ideas, and popularity rankings for the ideas, which may be related to a particular subject. Answers forums tab 1206, when selected, may cause a web page to appear that could be the home page of forums. Knowledge base tab 1208, when selected, may cause the knowledge base webpage with knowledge articles to appear. Documents tab 1210, when selected, may cause a webpage to appear listing the documents available to the user. Blogs tab 1212, when selected may cause a webpage to appear that has a blog. The users can read or contribute to the blog and the topic of the blog is not restricted to the forum topic. More resources tab 1214 when selected, may cause a menu with a listing of resources and links to those resources such as customer support contact to appear. Login or register tab 1216, when selected may cause a webpage to appear with login fields and/or a registration form. Search 1218 is a search form that accepts search terms to search in the entire website. Question box 1220, in contrast to search, is an input box for inputting a question. Continue button 1222, when selected, causes a search to be conducted in the forum and knowledge base with the keywords/question entered in question box 1220. Top contributors 1224 displays pictures of the users that have contributed the most to the forum. Frequently asked questions 1226 lists the most frequently asked questions in the forum. Additional support ideas 1228 lists support links in addition to the forum and the knowledge base. In an embodiment, link to program guides and social network websites, Facebook and Twitter are listed. Statistics 1230 lists the forum statistics including the number of topics posted, number of people in the forum, and the number of employees participating in the forum. Regional user groups 1232 lists other forums which are available in a geographical location. Ideas under construction 1234 lists the forum topics which are under consideration. Join the community 1236 section describes some of the activities a user can do by participating in the community/forum.

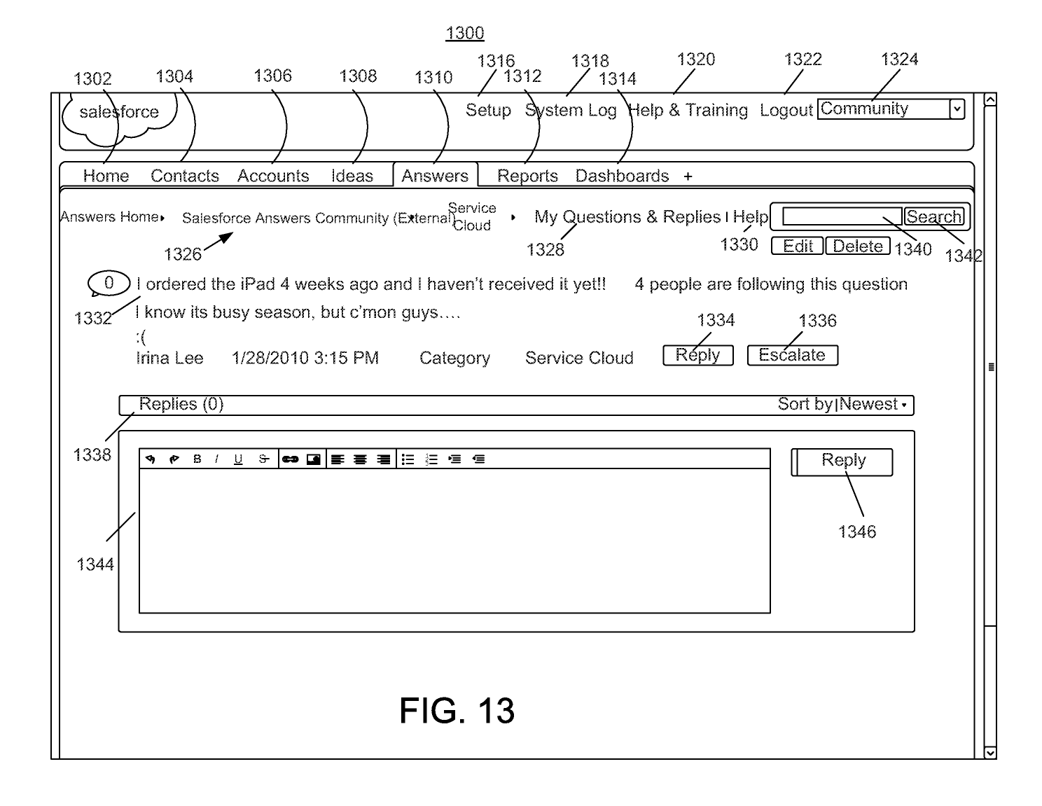

FIG. 13 shows screenshot 1300, an embodiment of an answer webpage. Screenshot 1300 may include the home tab 1302, contacts tab 1304, accounts tab 1306, ideas tab 1308, answers tab 1310, reports tab 1312, dashboards tab 1314, setup 1316, system log 1318, help & training 1320, logout 1322, pull down menu 1324, webpage hierarchy 1326, my questions & replies 1328, help 1330, forum question 1332, reply button 1334, escalate button 1336, number of replies 1338, search input box 1340, search button 1342, reply box 1344, and reply button 1346. In other embodiments, webpage 1300 may not have all of the elements listed and/or may have other elements instead of or in addition to those listed.

Screenshot 1300 is a webpage with an answer input box and links to access forum activities such as posting question, replying, escalating, and promoting. Home tab 1302, when selected, may cause a webpage to appear that may be the user's webpage or a home page similar to screenshot 1200. Contacts tab 1304, when selected, may cause a contacts webpage to appear that helps the user in creating and managing contacts. The contacts webpage may allow the viewing and editing of detailed information about the contacts. Accounts tab 1306, when selected, may cause an accounts-webpage to appear that lists the organization's customers. The accounts-webpage may have detailed information such as the name, address, phone numbers, and related information such as opportunities, activities, cases, partners, contracts, and notes. Ideas tab 1308 can be the same as ideas tab 1204. Answers tab 1310, when selected, may cause a question screenshot 1300 to appear. In the screenshot of FIG. 13, answers tab 1310 is highlighted indicating that the tab is currently selected. Reports tab 1312, when selected, may cause a reports webpage to appear. The reports webpage may be used to generate various kinds of reports. Reports may be organized in rows and columns and/or displayed graphically as a chart. The reports may facilitate monitoring activities of an organization. Dashboards tab 1314, when selected, causes a dashboard webpage to appear. The dashboard webpage shows data from reports as visual components, which can be charts, gauges, or tables. Dashboard webpage may provide a snapshot of key metrics and performance indicators and/or status of an organization. Setup 1316 link, when selected, causes a web page to appear for the user to setup the account options and preferences. System log 1318, when selected, causes a webpage to appear listing a log of the activities of the user. Help & training menu 1320, when selected, may cause a help page to appear describing the usage of the website and/or features of the website. Logout 1322, when selected, logs out a user from the forum. Pull down menu 1324, when selected, lists the various menu options. Community is displayed indicating the current selection. Webpage hierarchy 1326 displays the current webpages hierarchy or the access path. Screenshot 1300 can be viewed by selecting answers home tab 1310, then community menu and selecting the topic service cloud. My question & replies menu 1328 may link to a webpage which lists all the questions and replies posted by a user. Help menu 1330, when selected, may cause a help page to appear. The help page may give a description of the usage of the current webpage and/or features on the current webpage. Forum question 1332 may display the current forum conversation topic. Reply button 1334, when selected, can cause the reply box 1344 to appear below. Escalate 1336, when selected, can escalate the current forum question to the customer support management system. U.S. Provisional Patent application Ser. No. 61/350,904, filed Jun. 2, 2010, entitled “Methods and Systems for Answers to Cases Escalation,” and which is hereby incorporated herein by reference, teaches the escalation of a case to customer support management system. Number of replies 1338 may indicate the number of replies that has been posted for posted question 1332. Search input box 1340 may be a user interface for entering keywords to search the website. Search button 1342, when selected, may send a message to the server to search the website with the keywords entered in search input box 1340. Reply box 1344 is the input box for replies to the forum question 1332. The user system can post replies to questions posted in the forum, via reply box 1344. For example, replies entered in input box 1344 may be posted in forum 208 by selecting the reply button 1346. Selecting reply button 1346 may cause the reply to be posted in the forum.

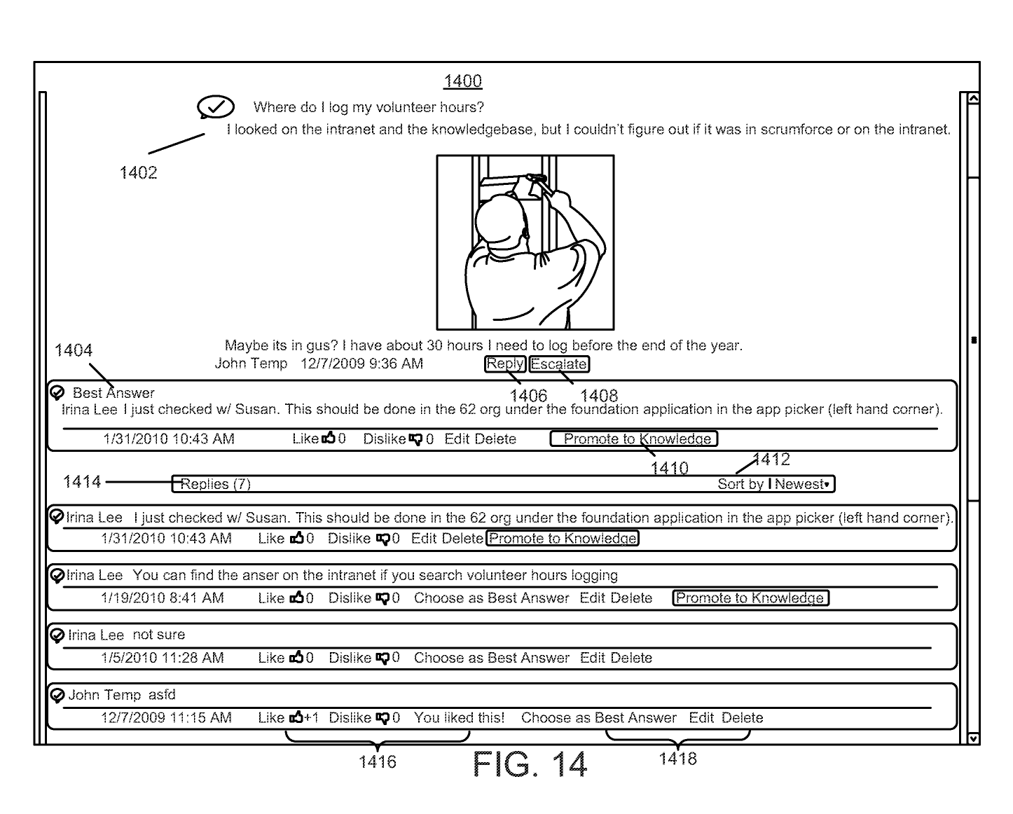

FIG. 14 shows screenshot 1400 of an embodiment of answers webpage. Screenshot 1400 may include forum question 1402, best answer 1404, reply button 1406, escalate button 1408, promote to knowledge base button 1410, sort replies 1412, number of replies 1414, voting like 1416, and voting best answer 1418. In other embodiments, webpage 1400 may not have all of the elements listed and/or may have other elements instead of or in addition to those listed.

In an embodiment, screenshot 1400 can have a top menu bar similar to screenshot 1400. After a reply is posted, the reply is visible to all the users of forum 208. Screenshot 1400 is a webpage that contains links for the user to participate in a forum by reading a posted question, replying, escalating a question, promoting an answer to knowledge base, and voting. Forum question 1402 displays the current forum question. Best answer 1404, displays an answer which was voted as best answer. Reply button 1406, when selected, causes a webpage with a reply box similar to reply box 1344 to appear. Escalate button 1408, when selected, escalates a forum question to the customer case management system. Promote to knowledge base button 1410, when selected, promotes a reply from a forum question to the knowledge base management system. Selecting sort replies 1412 may cause the replies to be sorted in alphabetical order, in the order of newest to oldest, in the order of oldest to newest, or in another order. Number of replies 1414 may indicate the number of replies that has been posted for a forum question 1402. In an embodiment, the user may indicate that the user likes/dislikes the reply by choosing the like link/dislike link. Voting like 1416 may include a like link and a dislike link for voting that the user likes or dislikes a question and/or answer. In an embodiment, voting like 1416 also displays the user's vote. Voting best answer 1418 includes choose as best answer link, edit link, and delete link. Authorized personnel can vote a reply to be the best answer by choosing the best answer link. Other privileges of authorized personnel may include editing the reply by choosing the edit link and deleting the reply by choosing the delete link. An authorized personnel may also promote a reply to knowledge base management system by choosing promote to knowledge base button 1410 or escalate to customer case management system by choosing the escalate button 1408. Escalation, promotion, and voting are discussed in detail in the U.S. Provisional Patent application Ser. No. 61/350,904, filed Jun. 2, 2010, entitled “Method and System for Answers to Cases Escalation.”

### System Overview

FIG. 15 illustrates an embodiment of a block diagram of an environment 1510 wherein an on-demand database service might be used. Environment 1510 may include user systems 1512, network 1514, system 1516, processor system 1517, application platform 1518, network interface 1520, tenant data storage 1522, system data storage 1524, program code 1526, and process space 1528. In other embodiments, environment 1510 may not have all of the components listed and/or may have other elements instead of, or in addition to, those listed above.

Environment 1510 is an environment in which an on-demand database service exists. User system 1512 may be any machine or system that is used by a user to access a database user system. For example, any of user systems 1512 can be a handheld computing device, a mobile phone, a laptop computer, a work station, and/or a network of computing devices. As illustrated in FIG. 15 (and in more detail in FIG. 16) user systems 1512 might interact via a network 1514 with an on-demand database service, which is system 1516.

An on-demand database service, such as system 1516, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 1516” and “system 1516” will be used interchangeably herein. A database image may include one or more database objects. A relational database management system (RDMS) or the equivalent may execute storage and retrieval of information against the database object(s). Application platform 1518 may be a framework that allows the applications of system 1516 to run, such as the hardware and/or software, e.g., the operating system. In an embodiment, on-demand database service 1516 may include an application platform 1518 that enables creation, managing, and executing one or more applications developed by the provider of the on-demand database service, users accessing the on-demand database service via user systems 1512, or third party application developers accessing the on-demand database service via user systems 1512.

The users of user systems 1512 may differ in their respective capacities, and the capacity of a particular user system 1512 might be entirely determined by permissions (permission levels) for the current user. For example, where a salesperson is using a particular user system 1512 to interact with system 1516 that user system has the capacities allotted to that salesperson. However, while an administrator is using that user system to interact with system 1516, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 1514 is any network or combination of networks of devices that communicate with one another. For example, network 1514 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 1512 might communicate with system 1516 using TCP/IP and, at a higher network level, use other common Internet protocols to communicate, such as HTTP, FTP, AFS, WAP, etc. In an example where HTTP is used, user system 1512 might include an HTTP client commonly referred to as a “browser” for sending and receiving HTTP messages to and from an HTTP server at system 1516. Such an HTTP server might be implemented as the sole network interface between system 1516 and network 1514, but other techniques might be used as well or instead. In some implementations, the interface between system 1516 and network 1514 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 1516, shown in FIG. 15, implements a web-based customer relationship management (CRM) system. For example, in one embodiment, system 1516 includes application servers configured to implement and execute CRM software applications as well as provide related data, code, forms, webpages and other information to and from user systems 1512 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 1516 implements applications other than, or in addition to, a CRM application. For example, system 1516 may provide tenant access to multiple hosted (standard and custom) applications, including a CRM application. User (or third party developer) applications, which may or may not include CRM, may be supported by the application platform 618, which manages creation, storage of the applications into one or more database objects, and executing of the applications in a virtual machine in the process space of the system 1516.

One arrangement for elements of system 1516 is shown in FIG. 15, including a network interface 1520, application platform 1518, tenant data storage 1522 for tenant data 1623, system data storage 1524 for system data 1625 accessible to system 1516 and possibly multiple tenants, program code 1526 for implementing various functions of system 1516, and a process space 1528 for executing MTS system processes and tenant-specific processes, such as running applications as part of an application hosting service. Additional processes that may execute on system 1516 include database indexing processes.

Several elements in the system shown in FIG. 15 include conventional, well-known elements that are explained only briefly here. For example, each user system 1512 could include a desktop personal computer, workstation, laptop, PDA, cell phone, or any wireless access protocol (WAP) enabled device or any other computing device capable of interfacing directly or indirectly to the Internet or other network connection. User system 1512 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 1512 to access, process and view information, pages and applications available to it from system 1516 over network 1514. Each user system 1512 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 1516 or other systems or servers. For example, the user interface device can be used to access data and applications hosted by system 1516, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 1512 and all of its components are operator configurable using applications, such as a browser, including computer code run using a central processing unit such as an Intel Pentium® processor or the like. Similarly, system 1516 (and additional instances of an MTS, where more than one is present) and all of their components might be operator configurable using application(s) including computer code to run using a central processing unit such as processor system 1517, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 1516 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 1516 is configured to provide webpages, forms, applications, data and media content to user (client) systems 1512 to support the access by user systems 1512 as tenants of system 1516. As such, system 1516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 16 also illustrates environment 1510. However, in FIG. 16 elements of system 1516 and various interconnections in an embodiment are further illustrated. FIG. 16 shows that user system 1512 may include processor system 1512A, memory system 1512B, input system 1512C, and output system 1512D. FIG. 15 shows network 1514 and system 1516. FIG. 16 also shows that system 1516 may include tenant data storage 1522, tenant data 1623, system data storage 1524, system data 1625, User Interface (UI) 1630, Application Program Interface (API) 1632, PL/SOQL 1634, save routines 1636, application setup mechanism 1638, applications servers 16001-1600N, system process space 1502, tenant process spaces 1504, tenant management process space 1510, tenant storage area 1512, user storage 1514, and application metadata 1516. In other embodiments, environment 1510 may not have the same elements as those listed above and/or may have other elements instead of, or in addition to, those listed above.

User system 1512, network 1514, system 1516, tenant data storage 1522, and system data storage 1524 were discussed above in FIG. 15. Regarding user system 1512, processor system 1512A may be any combination of one or more processors. Memory system 1512B may be any combination of one or more memory devices, short term, and/or long term memory. Input system 1512C may be any combination of input devices, such as one or more keyboards, mice, trackballs, scanners, cameras, and/or interfaces to networks. Output system 1512D may be any combination of output devices, such as one or more monitors, printers, and/or interfaces to networks. As shown by FIG. 15, system 1516 may include a network interface 1520 (of FIG. 15) implemented as a set of HTTP application servers 1600, an application platform 1518, tenant data storage 1522, and system data storage 1524. Also shown is system process space 1502, including individual tenant process spaces 1504 and a tenant management process space 1510. Each application server 1600 may be configured to tenant data storage 1522 and the tenant data 1623 therein, and system data storage 1524 and the system data 1625 therein to serve requests of user systems 1512. The tenant data 1623 might be divided into individual tenant storage areas 1512, which can be either a physical arrangement and/or a logical arrangement of data. Within each tenant storage area 1512, user storage 1514 and application metadata 1516 might be similarly allocated for each user. For example, a copy of a user's most recently used (MRU) items might be stored to user storage 1514. Similarly, a copy of MRU items for an entire organization that is a tenant might be stored to tenant storage area 1512. A UI 1630 provides a user interface and an API 1632 provides an application programmer interface to system 1516 resident processes to users and/or developers at user systems 1512. The tenant data and the system data may be stored in various databases, such as one or more Oracle™ databases.

Application platform 1518 includes an application setup mechanism 1638 that supports application developers' creation and management of applications, which may be saved as metadata into tenant data storage 1522 by save routines 1636 for execution by subscribers as one or more tenant process spaces 1504 managed by tenant management process 1510 for example. Invocations to such applications may be coded using PL/SOQL 1634 that provides a programming language style interface extension to API 1632. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manage retrieving application metadata 1516 for the subscriber making the invocation and executing the metadata as an application in a virtual machine.

Each application server 1600 may be communicably coupled to database systems, e.g., having access to system data 1625 and tenant data 1623, via a different network connection. For example, one application server 16001 might be coupled via the network 1514 (e.g., the Internet), another application server 1600N-1 might be coupled via a direct network link, and another application server 1600N might be coupled by yet a different network connection. Transfer Control Protocol and Internet Protocol (TCP/IP) are typical protocols for communicating between application servers 1600 and the database system. However, it will be apparent to one skilled in the art that other transport protocols may be used to optimize the system depending on the network interconnect used.

In certain embodiments, each application server 1600 is configured to handle requests for any user associated with any organization that is a tenant. Because it is desirable to be able to add and remove application servers from the server pool at any time for any reason, there is preferably no server affinity for a user and/or organization to a specific application server 1600. In one embodiment, therefore, an interface system implementing a load balancing function (e.g., an F5 Big-IP load balancer) is communicably coupled between the application servers 1600 and the user systems 1512 to distribute requests to the application servers 1600. In one embodiment, the load balancer uses a least connections algorithm to route user requests to the application servers 1600. Other examples of load balancing algorithms, such as round robin and observed response time, also can be used. For example, in certain embodiments, three consecutive requests from the same user could hit three different application servers 1600, and three requests from different users could hit the same application server 1600. In this manner, system 1516 is multi-tenant, wherein system 1516 handles storage of, and access to, different objects, data and applications across disparate users and organizations.

As an example of storage, one tenant might be a company that employs a sales force where each salesperson uses system 1516 to manage their sales process. Thus, a user might maintain contact data, leads data, customer follow-up data, performance data, goals and progress data, etc., all applicable to that user's personal sales process (e.g., in tenant data storage 1522). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 1516 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 1516 might also maintain system level data usable by multiple tenants or other data. Such system level data might include industry reports, news, postings, and the like that are sharable among tenants.

In certain embodiments, user systems 1512 (which may be client systems) communicate with application servers 1600 to request and update system-level and tenant-level data from system 1516 that may require sending one or more queries to tenant data storage 1522 and/or system data storage 1524. System 1516 (e.g., an application server 1600 in system 1516) automatically generates one or more SQL statements (e.g., one or more SQL queries) that are designed to access the desired information. System data storage 1524 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/8128,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

### Method for Using the Environment (FIGS. 15 and 16)

FIG. 17 shows a flowchart of an example of a method 1700 of using environment 1510. In step 1710, user system 1512 (FIGS. 15 and 16) establishes an account. In step 1712, one or more tenant process space 1604 (FIG. 16) are initiated on behalf of user system 1512, which may also involve setting aside space in tenant space 1612 (FIG. 16) and tenant data 1614 (FIG. 16) for user system 1512. Step 1712 may also involve modifying application metadata to accommodate user system 1512. In step 1714, user system 1512 uploads data. In step 1716, one or more data objects are added to tenant data 1614 where the data uploaded is stored. In step 1718, the methods associated with FIGS. 15-16 may be implemented. In another embodiment, although depicted as distinct steps in FIG. 18, steps 1702-1718 may not be distinct steps. In other embodiments, method 1700 may not have all of the above steps and/or may have other steps in addition to, or instead of, those listed above. The steps of method 1700 may be performed in another order. Subsets of the steps listed above as part of method 1700 may be used to form their own method.

### Method for Creating the Environment (FIGS. 15 and 16)

FIG. 18 is an example of a method of making environment 1510. In step 1802, user system 1512 (FIGS. 15 and 16) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another.

In step 1804, system 1516 (FIGS. 15 and 16) is assembled, which may include communicatively coupling one or more processors, one or more memory devices, one or more input devices (e.g., one or more mice, keyboards, and/or scanners), one or more output devices (e.g., one more printers, one or more interfaces to networks, and/or one or more monitors) to one another. Additionally assembling system 1516 may include installing application platform 1518, network interface 1520, tenant data storage 1522, system data storage 1524, system data 1625, program code 1526, process space 1528, UI 1630, API 1632, PL/SOQL 1634, save routine 1636, application setup mechanism 1638, applications servers 1600₁-1600_{N}, system process space 1602, tenant process spaces 1604, tenant management process space 1610, tenant space 1612, tenant data 1614, and application metadata 1616 (FIG. 17).

In step 1806, user system 1512 is communicatively coupled to network 1604. In step 1808, system 1516 is communicatively coupled to network 1604 allowing user system 1512 and system 1516 to communicate with one another (FIG. 17). In step 1810, one or more instructions may be installed in system 1516 (e.g., the instructions may be installed on one or more machine readable media, such as computer readable media, therein) and/or system 1516 is otherwise configured for performing the steps of methods associated with FIGS. 15-16. In an embodiment, each of the steps of method 1800 is a distinct step. In another embodiment, although depicted as distinct steps in FIG. 18, steps 1802-1810 may not be distinct steps. In other embodiments, method 1800 may not have all of the above steps and/or may have other steps in addition to, or instead of, those listed above. The steps of method 1800 may be performed in another order. Subsets of the steps listed above as part of method 1800 may be used to form their own method.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

### Extensions and Alternatives

In an alternate embodiment the internal forum and the internal knowledge base can be accessed via the social network service.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method for providing answers to a user system from a forum system in a multi-tenant database system, comprising:
at a host system of the forum system, receiving, at least a message having information that results from a user interacting with a webpage, the information including a question from the user system via a host system of a social network, the host system of the forum system including one or more machines including a processor system having at least one or more processors and a memory system, the question having originated at a user system;
sending from the host system of the forum system, a webpage of answers to the user system via the host system of the social network system.

2. A method of claim 1 where the forum system comprises at least a forum having a storage area including user contributed questions and answers related to a topic of interest to the forum and a knowledge base including at least information taken from user contributions to the forum.

3. The method of claim 2, the at least one webpage sent to the social network including regional user groups listed in the forum.

4. The method of claim 2, the at least one webpage sent to the social network including ideas under consideration listed in the forum.

5. The method of claim 2 where frequently asked questions are listed in the forum.

6. The method of claim 2 further comprises:
sending by the forum system a code to the social network system, which when implemented causes a link to the forum to be created on a webpage of the social network system.

7. The method of claim 6 further comprises:
receiving from the webpage of the social network system a selection of the link and the login information;
in response validating the login, and sending a webpage from the forum system to the social network system.

8. The method of claim 1, wherein the forum system and the social network are independent of one another.

9. The method of claim 1, further comprising in response to receiving the question, searching the forum system for the webpage of answers.

10. The method of claim 9 further includes searching a categories table listing categories of the forum and the knowledge base.

11. The method of claim 10, wherein the forum and knowledge base have pointers to the categories table.

12. The method of claim 1, wherein the forum system comprises an internal forum and an internal knowledge base and access is restricted from clients of tenants but not to employees of the tenant.

13. The method of claim 1, the at least one web page including a question posted by the user system in the forum.

14. The method of claim 1, the at least one webpage sent to the social network including at least a reply to questions posted in the forum.

15. The method of claim 1, the at least one webpage sent to the social network including a vote on the reply to questions.

16. The method of claim 1:
further comprises:
prior to the receiving of the question, sending by the forum system a code to the social network system, the forum system comprises at least a forum having a storage area including user contributed questions and answers related to a topic of interest to the forum and a knowledge base including at least information taken from user contributions to the forum, which when implemented causes a link to the forum to be created on a webpage of the social network system;
receiving from the social network system a selection of the link and the login information;
in response, validating the login, and sending a webpage from the forum system to the social network system;
after the receiving of the question, searching the forum system for the webpage of answers;
wherein:
the forum and knowledge base have pointers to a categories table and searching the categories table listing categories of the forum and the knowledge base;
the forum system and the social network are independent of one another;
the at least one web page including the question posted by the user system in the forum;
the at least one webpage sent to the social network including at least a reply to questions posted in the forum;
the at least one webpage sent to the social network including a vote on the reply to questions;
the at least one webpage sent to the social network including regional user groups listed in the forum;
a frequently asked questions are listed in the forum.

17. A machine comprising:
machine readable media, storing thereon one or more instructions for implementing a web application that includes one or more instructions that cause the processor system to perform a method including at least:
at a host system of the forum, receiving, a question from the host system of a social network, the host system of the forum including one or more machines including a processor system having at least one or more processors and a memory system, the question having originated at a user system;
sending from the host system of the forum, a webpage of answers to the host system of the social network system.

18. A machine-readable medium carrying one or more sequences of instructions for implementing a method for providing an interface for object relationships, the method comprising:
at a host system of the forum, receiving, a question from the host system of a social network, the host system of the forum including one or more machines including a processor system having at least one or more processors and a memory system, the question having originated at a user system;
sending from the host system of the forum, a webpage of answers to the host system of the social network system.
